(19) United States
(12) Patent Application Publication
(10) Pub. No.: US 2016/0099847 A1
(43) Pub. Date: Apr. 7, 2016

(54) METHOD FOR NON-DISRUPTIVE CLOUD INFRASTRUCTURE SOFTWARE COMPONENT DEPLOYMENT

(71) Applicant: Cisco Technology, Inc., San Jose, CA (US)

(72) Inventors: Bob Melander, Stockholm (SE); Hareesh Puthalath, Stockholm (SE)

(21) Appl. No.: 14/504,929

(22) Filed: Oct. 2, 2014

(51) Int. Cl. H04L 12/24; H04L 29/08

(52) U.S. Cl. CPC H04L 41/5051; H04L 41/0806; H04L 67/10

(57) ABSTRACT

The subject technology provides embodiments for defining, using a first application programming interface (API), a logical resource variant of a logical service resource. The logical resource variant is registered at a defining entity. Software components for the logical resource variant are then sent to a Infrastructure as a Service (IaaS) system to associate the software components with the logical resource variant. A call, from a second API, is received to enable create, read, update and delete (CRUD) operations for the logical resource variant. An instantiating entity is assigned for the logical resource variant of the logical service resource. It is then requested to the assigned instantiating entity to instantiate and configure the logical resource variant of the logical service resource.

### TECHNICAL FIELD

Embodiments presented in this disclosure generally relate to techniques for providing a computing infrastructure for logical service resources and more particularly, to a method and apparatus for providing, maintaining and supporting logical service resources in an Infrastructure as a Service (IaaS) cloud environment.

### BACKGROUND

An Infrastructure as a Service (IaaS) cloud environment may provide, to a consumer or client, processing, storage, networks, and other fundamental computing resources such that the consumer is able to deploy and run software, which can include operating systems and applications. In some instances, the consumer does not manage or control the underlying cloud infrastructure but has control over operating systems, storage, deployed applications, and possibly limited control of select networking components (e.g., firewalls).

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example computing environment in which some embodiments of the subject technology may be implemented;

FIG. 2A conceptually illustrates an example process to process, on at least a defining entity side, a request to instantiate a cloud infrastructure service associated with a logical resource variant in accordance with some embodiments of the subject technology;

FIG. 2B conceptually illustrates an example process to instantiate and configure, on an instantiating entity side, a cloud infrastructure service associated with a logical resource variant in accordance with some embodiments of the subject technology;

FIG. 3 illustrates an example network device according to some aspects of the subject technology;

FIGS. 4A and 4B illustrate example system embodiments according to some aspects of the subject technology.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

The subject technology provides embodiments for defining, using a first application programming interface (API), a logical resource variant of a logical service resource. As used herein, the terms “variant” or “flavor” are used interchangeably to refer, in a synonymous manner, to a type or kind of logical service resource. The logical resource variant is registered at a defining entity. Software components for the logical resource variant are then sent to an Infrastructure as a Service (IaaS) system to associate the software components with the logical resource variant. Those software components are used by the IaaS to realize instances of the logical resource variant. A call, from a second API, is received to enable create, read, update and delete (CRUD) operations for the logical resource variant. An instantiating entity is assigned for the logical resource variant of the logical service resource. It is then requested, to the assigned instantiating entity, to instantiate and configure the logical resource variant of the logical service resource.

### Description

In the context of information technology, cloud computing is a model of service delivery (e.g., instead of a product) for providing on-demand access to shared computing resources (e.g., networks, network bandwidth, servers, processing, memory, storage, applications, virtual machines, virtual appliances, and services) that can be provisioned with very little management effort or interaction with a provider of the service. In some instances, cloud infrastructure (“cloud”) may be deployed as a public, private or hybrid cloud. By way of example, in a private cloud, the cloud infrastructure is operated solely for an entity, and may be managed by the entity (or third party). In a public cloud, the cloud infrastructure may be made available to the general public (or another large set of users) and is operated by an entity providing cloud services. In a hybrid cloud, the cloud infrastructure includes at least two clouds (e.g., private and/or public) that are separate but connected by technology that enables data and/or application interoperability.

Infrastructure-as-a-Service (IaaS) clouds (as public, private or hybrid clouds), has attracted interest among different parties. The promise of very flexible and cost-efficient information technology is a key driver for this interest. A cloud-based solution can achieve economies of scale that traditional deployment and operational models may not be able to match. To achieve economies of scale, automation of processes may be necessary. Human intervention, essentially manual work tasks by the (cloud) system administrators, should be kept at a minimum. The methodologies and techniques to deal with challenges to achieve economies of scale (among others) have evolved to a discipline of its own: Dev-Ops. DevOps (e.g., a portmanteau of development and operations) is a software development technique that emphasizes communication, collaboration and integration between software developers and information technology (IT) operations professionals to help an organization quickly produce software products and services.

A cloud deployment may not appear in a “completed” state in the sense that new or upgraded software components may need to be applied over time to such software components. This may be due to bug fixes or to add new features or capabilities required or requested by customer/users. Tool suites have been developed to support bug fixes and new features. However, these kind of tools are typically not integrated in the operational workflows of the cloud infrastructure services (e.g., routing, VPN, firewall-as-a-Service). One important reason is that, while such tools are highly configurable and can be part of a larger continuous integration process, these tools are primarily designed and geared towards being applied at discrete moments in time. These tools therefore are less suited to be part of the continuous, real-time workflow of an infrastructure service provided by a given cloud.

To provide a more concrete example, consider the following common cloud IaaS service design pattern: a REST API (e.g., representational state transfer (REST) is an abstraction of the architecture of the World Wide Web) and database (DB) processing component in Openstack's (e.g., an open source cloud computing platform for public and private clouds) network service Neutron (this component is called a “plugin”). There is also an “agent” component that applies configurations in “hosting devices” such as servers and physical or virtual network devices, etc. In at least one embodiment, the agent instantiates the logical resources in the hosting devices so that the functionality becomes operational. There can be many agents in an IaaS deployment (e.g., for redundancy and scaling reasons).

To support service differentiation through variants (or, synonymously, flavors) and, which is often coupled to the aforementioned, to support the multitude of hosting devices with different capabilities, the plugins and the agents often use “drivers.” In an example, Service A (e.g., a virtual private network service) in a hosting device B (e.g., a top of rack switch) needs a set of drivers, while the same service A in hosting device C (e.g., a software router in a virtual machine) needs another driver set.

While introduction of hardware devices normally happen over longer time scales due to procurement and delivery processes, virtual appliances (e.g., a virtualized software router) can be introduced much faster since it is basically software. Virtual appliances (e.g., a pre-configured virtual machine image, ready to run on a hypervisor) also open a possibility that the user of the cloud is the one that brings the (virtual) device rather than the cloud provider. User provided (e.g., virtual) devices to be incorporated in the cloud service framework using REST APIs is a use case that is even less compatible with some existing tool suites. In any case, adding the drivers (or other software components) to a large number of agents at possibly unpredictable points in time may require tool(s) and framework support that is still largely missing from some existing implementations.

Embodiments of the subject technology therefore provide configurations in order to fill this capability gap to better support cloud infrastructure services that use design patterns with a defining entity (e.g., server or plugin) and an instantiating entity (e.g., agent). In particular, embodiments disclosed herein provide techniques that allow administrators (or users), to dynamically introduce software components, in particular drivers, to a running cloud service so that software components (e.g., drivers utilized by cloud services, etc.) are automatically included in the service's operational workflows.

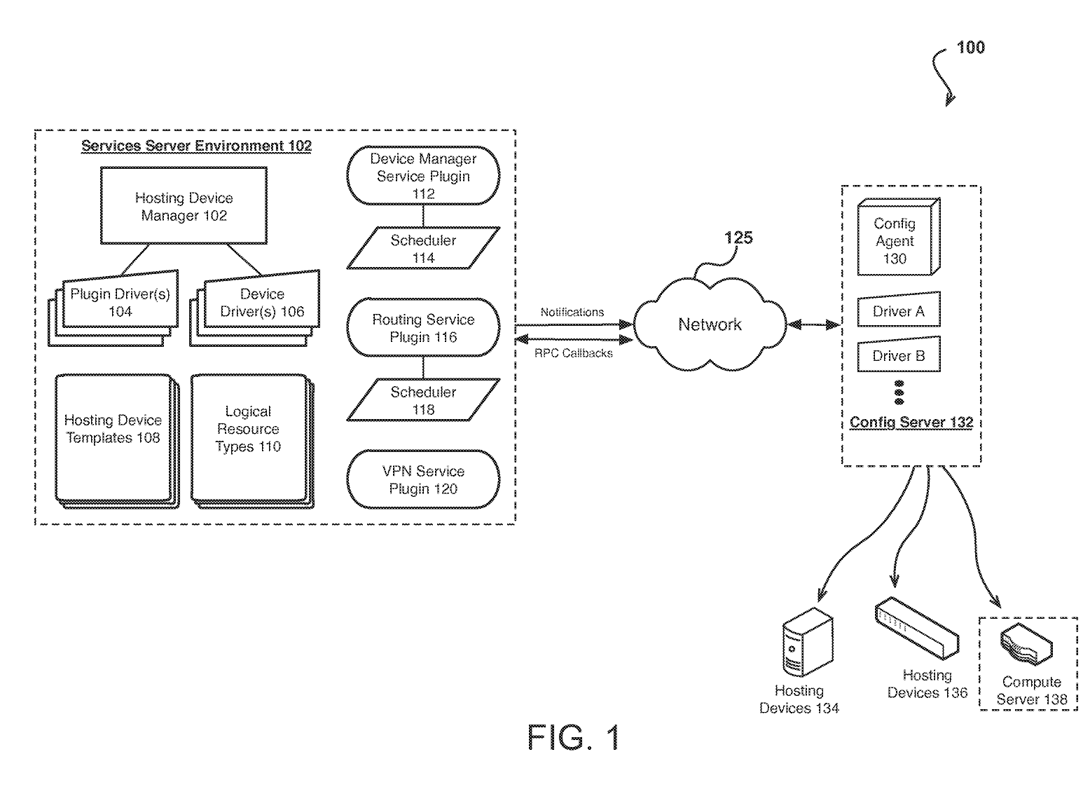

FIG. 1 illustrates an example computing environment 100 in which some embodiments of the subject technology may be implemented. As shown, the computing environment 100 includes a services server environment 102, which includes several components for implementing aspects in accordance with various embodiments, as may be used to support various services and/or applications. A hosting device manager 102 manages plugin drivers 104 and device drivers 106, including new and updated plugin drivers and device drivers for providing to various cloud services that are currently running on respective hosting devices. In one example, the plugin drivers represent software components that are used by various service plugins on the services server environment 102, and the device drivers 106 represent software components that are used by an instantiating entity (e.g., a configuration agent 130 as discussed further herein) for instantiating and configuring different cloud infrastructure services for deployment on hosting devices.

In at least one embodiment, the hosting device manager 102 relays one or more user requests from a REST API (or other suitable API) to one or more plugins in the services server environment 102. Additionally, in one embodiment, a request to instantiate a particular type of plugin can result in the hosting device manager 102 instantiating the requested type of plugin.

In one example, a device manager service plugin 112 can process a request from the REST API as relayed from the hosting device manager 102 to handle hosting device templates. The device manager service plugin 112 may manage the lifecycle and perform health management of one or more hosting devices for cloud infrastructure services and also control allocation of processing capacity in such hosting devices.

In some embodiments, communication between components of the services server environment 102 may occur over a network 125. The network 125 can include any appropriate network, including an intranet, the Internet, a cellular network, a local area network or any other such network or combination thereof. Communication over the network 125 can be enabled via wired or wireless connections and combinations thereof.

As further shown, the device manager service plugin 112 may communicate with a scheduler 114. The scheduler 114 may communicate, over the network 125, with a configuration agent 130 and send one or more notifications to the configuration agent 130 regarding updates or changes to drivers and configuration information for the cloud infrastructure services on hosting devices. However, it is appreciated that in some embodiments, the device manager service plugin 112 may communicate directly with the configuration agent 130. The configuration agent 130 in this example services as an instantiating entity for cloud infrastructure services provided by the service plugins in the services server environment 102.

In at least one embodiment, the configuration agent 130 applies configurations in hosting devices on behalf of respective service plugins and may monitor the health of the hosting devices. Further, the communication between the configuration agent 130 and respective service plugins from the services server environment 102 may be accomplished using RPC (remote procedure calls) so that the configuration agent 130 may receive updated software components and/or drivers. In one example, the configuration agent 130 may invoke RPC callbacks to respective service plugins to receive updated drivers and/or components. An RPC callback, as used herein, may refer to executable code that is passed as an argument to other code, which is expected to call back (execute) the argument at some future time, and the invocation may be substantially immediate as in a synchronous callback or may occur at later time, as in an asynchronous callback.

As further shown, a routing service plugin 116 communicates with a scheduler 118 to provide notifications, over the network 125, to the configuration agent 130 regarding updates to software components and/or drivers for a virtual router cloud service(s) running on respective hosting devices. Such notifications may be provided via a push or pull technique and/or be received in a periodic manner or at predefined time intervals. A virtual private network (VPN) service plugin 120 may also communicate over the network 125 regarding the information and updates for software components of the VPN service running on one or more hosting devices. Firewall-as-a-Service and Loadbalancer-as-a-Service are two other cloud network services that could equally well use this method. Storage services in an IaaS cloud are another class of services.

As further shown, a plurality of logical resource types 110 (e.g., logical resource variants, flavors) includes information related to different types of cloud infrastructure services such as different types of virtual routers, firewalls, VPNs, etc. Such information may include information regarding the types of driver(s) and/or software components needed to instantiate respective logical resource types of cloud infrastructure services as well as variant specific settings. Hosting device templates 108 may include information regarding configuration of different types of hosting devices in order to support cloud infrastructure services. In at least one embodiment, a respective hosting device template may be used in conjunction with a logical resource type to deploy a respective cloud infrastructure service. For example, a hosting device template may include information that describes the configuration of a particular hosting device (e.g., to bootstrap the hosting device), which may be used with information from a logical resource type(s) by the configuration agent 130 to instantiate and configure a respective cloud infrastructure service.

In an example, the configuration agent 130 resides on a configuration server 132, which is a separate machine, computing device and/or network node that executes the configuration agent 130. The configuration agent 130 running on the configuration server 132 receives the notifications from one or more of the service plugins from the services server environment 102. Further, the configuration agent 130 may invoke respective RPC callbacks to receive updated software components and/or drivers for cloud infrastructure services running on hosting devices 134, 136 or compute server 138. As shown, drivers A and B are stored on the configuration server 132, and may represent updated drivers that are required for respective cloud infrastructure services. It is appreciated that fewer or more drivers may be stored on the configuration server 132 and still be within the scope of the subject technology. In one example, the compute server 138 is a virtual machine that hosts that cloud service (e.g., a virtual router). Each hosting device may be located in different networks or geographical regions or locations in at least one embodiment, or grouped together according to geographical region (e.g., 1 geographical region, 2 geographical regions, etc.).

Although the example of FIG. 1 illustrates that the configuration server 132 as being separate from the services server environment 102, it is appreciated that in some embodiments a single server or environment may be used to include the configuration server 132 and the services server environment 102.

In at least one embodiment, a cloud IaaS system (CIS), (e.g., Openstack's Neutron), which uses (the single or one of several) a design pattern with defining entities (DE) and instantiating entities IE (e.g., as shown in the example of FIG. 1 described above). For example, by reference to FIG. 1, the defining entities are the service plugins (e.g., the device manger service plugin 112, the routing service plugin 116 and/or the VPN service plugin 120) included in the services server environment 102 and the instantiating entity is typically an agent (e.g., the configuration agent 130) in at least one embodiment.

Through the services provided by the CIS, users can create logical service resources (LSR) (e.g., cloud infrastructure services where examples could be virtual routers and virtual firewalls among other types of logical service resources). There may be multiple variations or “flavors” of an LSR for a given cloud infrastructure service. Such variations may be called logical resource variants (LRV) as referred to herein and in a minimal form, a given LRV may be a name associated with the variation and/or including additional metadata. LRV examples may include a “hi-end” variation, an “advanced” variation, an “extended” variation, a “basic” variation or some other name or moniker that is meaningful to describe that variation. A particular LRV requires certain software, (e.g., a driver as referred to herein), as provided or hosted in the DE, to be able to be instantiated and configured. The DE side software as referred to herein may be called “DES”. The same LRV may also require some software in the IE side to enable the LRV to perform create, read, update and delete (CRUD) operation(s). The IE side software as referred to herein may be called “IES”.

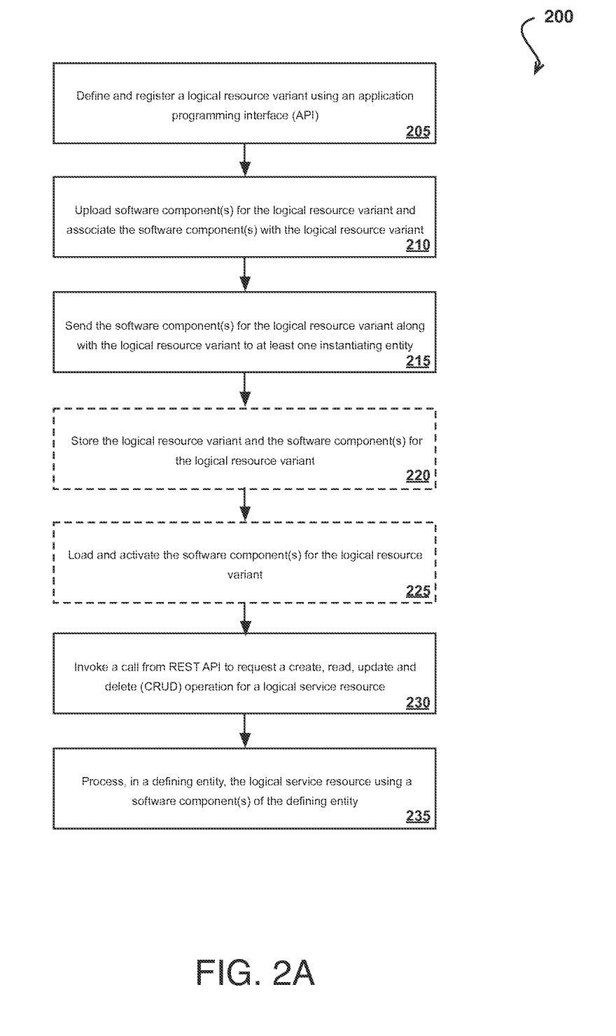

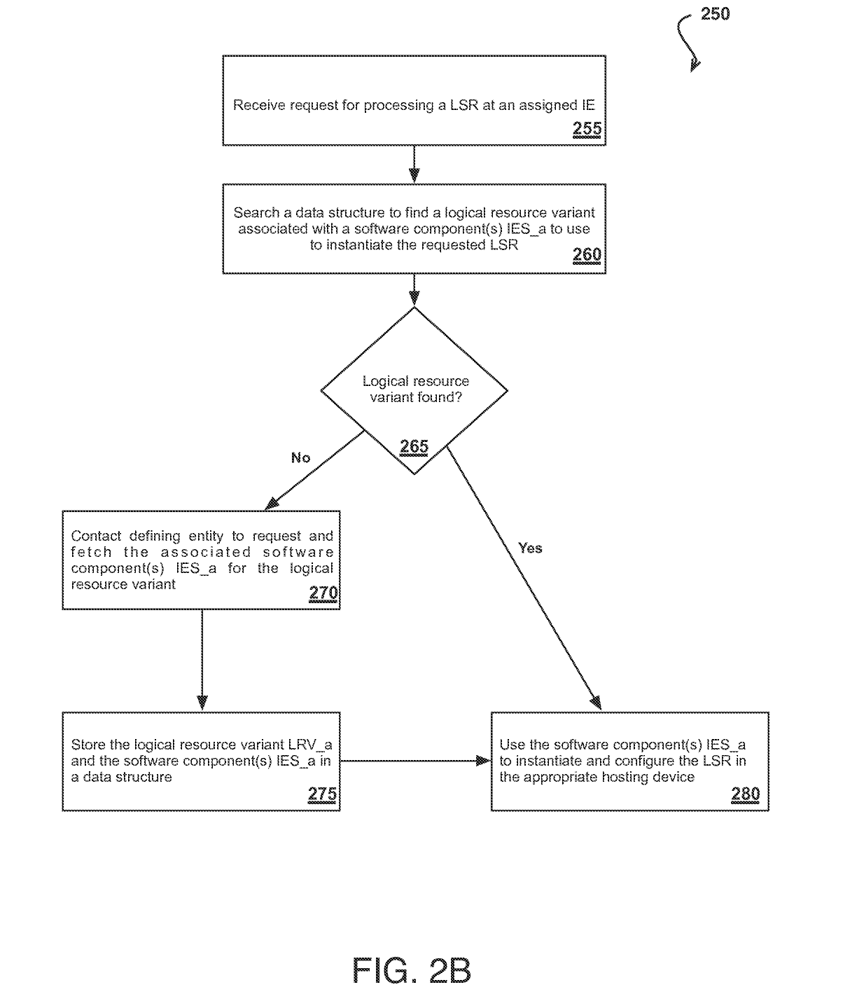

The following discussion describes an example process flow in order to create and register a logical resource variant and provide any software components (e.g., a driver(s)) for the logical resource variant to properly execute a cloud infrastructure service associated with the logical resource variant. This is typically done by a CIS administrator. FIG. 2A conceptually illustrates an example process 200 to process, on at least a defining entity side, a request to instantiate a cloud infrastructure service associated with a logical resource variant in accordance with some embodiments of the subject technology. The process 200 may be applicable in at least one embodiment to update software components for an existing logical resource variant that is currently running on a hosting computing device.

At step 205, a logical resource variant LRV_a is defined and registered in the cloud IaaS system (CIS) using a given application programming interface (API) (e.g., through an extension of the CIS REST API). At step 210, using the same API, software for the logical resource variant LRV_a, (e.g., IES_a and possibly also DES_a), is uploaded to the CIS and associated with the logical resource variant LRV_a. In one embodiment, the association with the logical resource variant LRV_a and the DES_a and IES_a are stored in a database (DB) and/or file system.

At step 215, in some embodiments (e.g., a pro-active workflow version), the CIS pushes the software component(s) IES_a (e.g., a driver(s)) along with the logical resource variant LRV_a to at least some of the IEs in the CIS deployment. At step 220, each IE (e.g., a configuration agent as described by reference to FIG. 1) that receives the software component(s) IES_a and the logical resource variant LRV_a stores the logical resource variant LRV and the software component(s) IES_a in a data structure and/or file system and/or in a DB. At step 225, each IE then loads and activates the software component(s) IES_a to enable it for usage. In one example, classes are loaded from received Python modules and object(s) are created for those classes. Alternatively, in an example for a reactive, on-demand version, steps 215, 220 and 225 are skipped (e.g., all no-ops or non-operations)

A step 230, a user (or admin, or other system, software component, script, etc.) invokes a call using the CIS REST API to enable a LSR (e.g., a virtual router, virtual firewall, etc.) of variant LRV_a to perform create, read, update and delete (CRUD) operations for various aspects of the LSR. In at least one embodiment, the “attributes” of the LSR may differ as such attributes are likely to be service type specific. For example, a Create or Update request for a firewall service may contain attributes indicating which interface the firewall will apply firewall policies on. In another example, a VPN Create or Update request may include attribute(s) indicating the remote peer of the VPN. Thus, the CIS REST API receives a request to invoke the create, read, update and delete (CRUD) operation(s) to enable the LSR to perform such operations.

At step 235, the DE in the CIS uses a software component(s) DES_a for processing the requested LSR. The DE (or some other component of the CIS in another embodiment) also assigns an IE (instantiating entity) for the LSR and instructs the assigned IE (using some communication mechanism like RPC, notifications, etc.) to instantiate and configure the LSR by sending a processing request to the assigned IE. In at least one embodiment, this processing request may include the logical resource variant LRV_a and information about which hosting device(s) should host the LSR.

FIG. 2B conceptually illustrates an example process 250 to instantiate and configure, on an instantiating entity side, a cloud infrastructure service associated with a logical resource variant in accordance with some embodiments of the subject technology. The process 250 may be applicable in at least one embodiment to update software components for an existing logical resource variant that is currently running on the hosting computing device. In one embodiment, the process 250 may be performed in conjunction with the process 200 described in FIG. 2A.

As discussed before, an IE may use software component(s) IES_a in order to instantiate a given LSR. Thus, in at least one embodiment, there is an association between 1) the software component(s) IES_a that the IE uses to instantiate a requested LSR and 2) the requested LSR. At step 255, a request from a DE for processing (e.g., instantiating and configuring) a LSR is received at an assigned IE (e.g., the IE assigned to instantiate and configure a given LSR). The request includes a logical resource variant LRV_a and information about which hosting device(s) should host the LSR in at least one embodiment. At step 260, the assigned IE, upon receiving the request for processing the LSR from the DE, determines by searching a data structure (or other storage location, DB or file system, etc.) to find a logical resource variant LRV_a associated with a software component(s) IES (e.g., driver(s), etc.) to use to instantiate the requested LSR.

At step 265, if the software component(s) LRV_a is not known to the IE (e.g., not found in the data structure), the IE at step 270 contacts the DE (or other component in CIS) to request and fetch the associated software component(s) IES_a for the logical resource variant LRV_a. At step 275, the IE stores the LRV_a and the software component(s) IES_a in a data structure and/or file system and/or DB. At step 280, the IE uses the software component(s) IES to instantiate and configure the LSR in the appropriate hosting device. Alternatively, if the LRV_a is known to the IE at step 265, the IE at step 280 uses the software component(s) IES_a to instantiate and configure the LSR in the appropriate hosting device.

In some embodiments, the subject technology may be utilized in a computer network environment. A computer network is a geographically distributed collection of nodes interconnected by communication links and segments for transporting data between endpoints, such as personal computers and workstations. Many types of networks are available, with the types ranging from local area networks (LANs) and wide area networks (WANs) to overlay and software-defined networks, such as virtual extensible local area networks (VXLANs).

LANs typically connect nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links. LANs and WANs can include layer 2 (L2) and/or layer 3 (L3) networks and devices.

The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol can refer to a set of rules defining how the nodes interact with each other. Computer networks may be further interconnected by an intermediate network node, such as a router, to extend the effective “size” of each network.

Overlay networks generally allow virtual networks to be created and layered over a physical network infrastructure. Overlay network protocols, such as Virtual Extensible LAN (VXLAN), Network Virtualization using Generic Routing Encapsulation (NVGRE), Network Virtualization Overlays (NVO3), and Stateless Transport Tunneling (STT), provide a traffic encapsulation scheme which allows network traffic to be carried across L2 and L3 networks over a logical tunnel. Such logical tunnels can be originated and terminated through virtual tunnel end points (VTEPs).

Moreover, overlay networks can include virtual segments, such as VXLAN segments in a VXLAN overlay network, which can include virtual L2 and/or L3 overlay networks over which VMs communicate. The virtual segments can be identified through a virtual network identifier (VNI), such as a VXLAN network identifier, which can specifically identify an associated virtual segment or domain.

Network virtualization allows hardware and software resources to be combined in a virtual network. For example, network virtualization can allow multiple numbers of VMs to be attached to the physical network via respective virtual LANs (VLANs). The VMs can be grouped according to their respective VLAN, and can communicate with other VMs as well as other devices on the internal or external network.

Network segments, such as physical or virtual segments; networks; devices; ports; physical or logical links; and/or traffic in general can be grouped into a bridge or flood domain. A bridge domain or flood domain can represent a broadcast domain, such as an L2 broadcast domain. A bridge domain or flood domain can include a single subnet, but can also include multiple subnets. Moreover, a bridge domain can be associated with a bridge domain interface on a network device, such as a switch. A bridge domain interface can be a logical interface which supports traffic between an L2 bridged network and an L3 routed network. In addition, a bridge domain interface can support Internet protocol (IP) termination, VPN termination, address resolution handling, MAC addressing, etc. Both bridge domains and bridge domain interfaces can be identified by a same index or identifier.

Furthermore, endpoint groups (EPGs) can be used in a network for mapping applications to the network. In particular, EPGs can use a grouping of application endpoints in a network to apply connectivity and policy to the group of applications. EPGs can act as a container for buckets or collections of applications, or application components, and tiers for implementing forwarding and policy logic. EPGs also allow separation of network policy, security, and forwarding from addressing by instead using logical application boundaries.

Cloud computing can also be provided in one or more networks to provide computing services using shared resources. Cloud computing can generally include Internet-based computing in which computing resources are dynamically provisioned and allocated to client or user computers or other devices on-demand, from a collection of resources available via the network (e.g., “the cloud”). Cloud computing resources, for example, can include any type of resource, such as computing, storage, and network devices, virtual machines (VMs), etc. For instance, resources may include service devices (firewalls, deep packet inspectors, traffic monitors, load balancers, etc.), compute/processing devices (servers, CPU's, memory, brute force processing capability), storage devices (e.g., network attached storages, storage area network devices), etc. In addition, such resources may be used to support virtual networks, virtual machines (VM), databases, applications (Apps), etc.

Cloud computing resources may include a “private cloud,” a “public cloud,” and/or a “hybrid cloud.” A “hybrid cloud” can be a cloud infrastructure composed of two or more clouds that inter-operate or federate through technology. In essence, a hybrid cloud is an interaction between private and public clouds where a private cloud joins a public cloud and utilizes public cloud resources in a secure and scalable manner. Cloud computing resources can also be provisioned via virtual networks in an overlay network, such as a VXLAN.

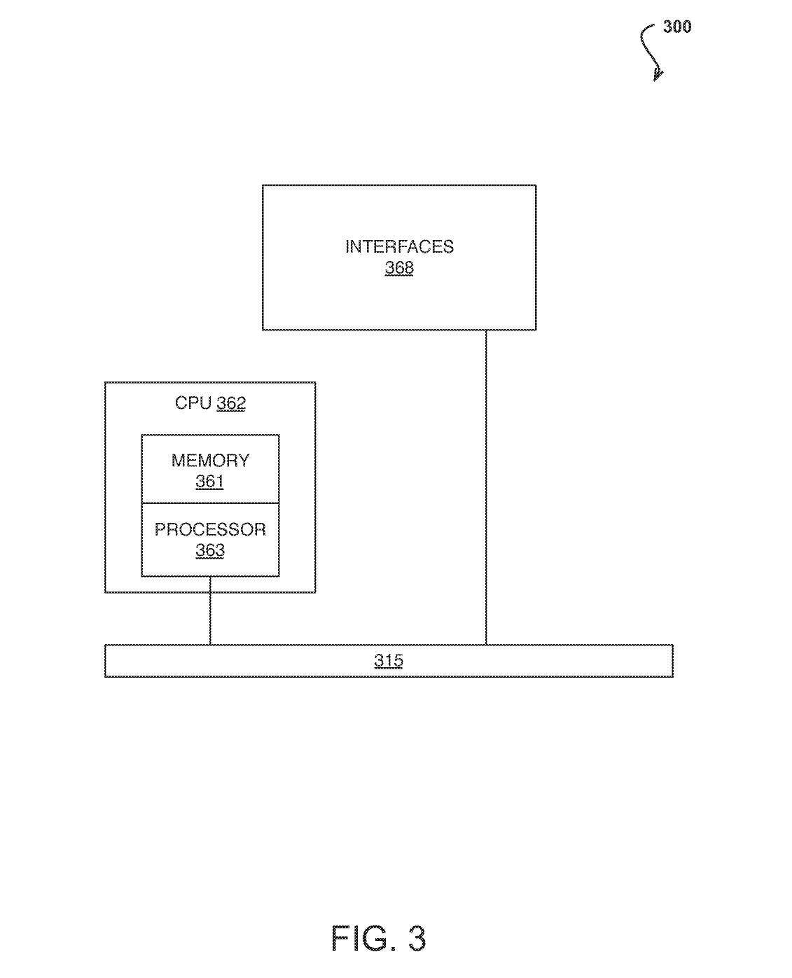

FIG. 3 illustrates an exemplary network device 310 suitable for implementing the present invention. Network device 310 includes a master central processing unit (CPU) 362, interfaces 368, and a bus 315 (e.g., a PCI bus). When acting under the control of appropriate software or firmware, the CPU 362 is responsible for executing packet management, error detection, and/or routing functions, such as miscabling detection functions, for example. The CPU 362 preferably accomplishes all these functions under the control of software including an operating system and any appropriate applications software. CPU 362 may include one or more processors 363 such as a processor from the Motorola family of microprocessors or the MIPS family of microprocessors. In an alternative embodiment, processor 363 is specially designed hardware for controlling the operations of router 310. In a specific embodiment, a memory 361 (such as non-volatile RAM and/or ROM) also forms part of CPU 362. However, there are many different ways in which memory could be coupled to the system.

The interfaces 368 are typically provided as interface cards (sometimes referred to as “line cards”). Generally, they control the sending and receiving of data packets over the network and sometimes support other peripherals used with the router 310. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 362 to efficiently perform routing computations, network diagnostics, security functions, etc.

Although the system shown in FIG. 3 is one specific network device of the present invention, it is by no means the only network device architecture on which the present invention can be implemented. For example, an architecture having a single processor that handles communications as well as routing computations, etc. is often used. Further, other types of interfaces and media could also be used with the router.

Regardless of the network device's configuration, it may employ one or more memories or memory modules (including memory 361) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc.

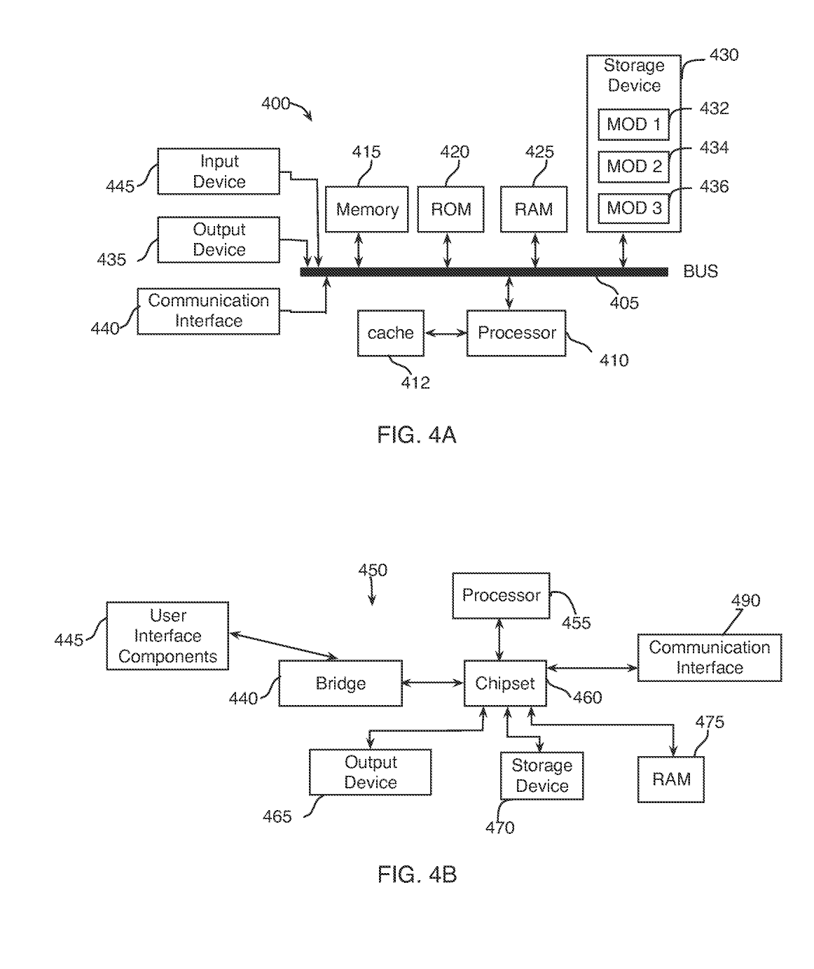

FIG. 4A, and FIG. 4B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 4A illustrates a conventional system bus computing system architecture 400 wherein the components of the system are in electrical communication with each other using a bus 405. Exemplary system 400 includes a processing unit (CPU or processor) 410 and a system bus 405 that couples various system components including the system memory 415, such as read only memory (ROM) 420 and random access memory (RAM) 425, to the processor 410. The system 400 can include a cache of high-speed memory connected directly with, in close proximity to, or integrated as part of the processor 410. The system 400 can copy data from the memory 415 and/or the storage device 430 to the cache 412 for quick access by the processor 410. In this way, the cache can provide a performance boost that avoids processor 410 delays while waiting for data. These and other modules can control or be configured to control the processor 410 to perform various actions. Other system memory 415 may be available for use as well. The memory 415 can include multiple different types of memory with different performance characteristics. The processor 410 can include any general purpose processor and a hardware module or software module, such as module 1 432, module 4 434, and module 3 436 stored in storage device 430, configured to control the processor 410 as well as a special-purpose processor where software instructions are incorporated into the actual processor design. The processor 410 may essentially be a completely self-contained computing system, containing multiple cores or processors, a bus, memory controller, cache, etc. A multi-core processor may be symmetric or asymmetric.

To enable user interaction with the computing device 400, an input device 445 can represent any number of input mechanisms, such as a microphone for speech, a touch-sensitive screen for gesture or graphical input, keyboard, mouse, motion input, speech and so forth. An output device 435 can also be one or more of a number of output mechanisms known to those of skill in the art. In some instances, multimodal systems can enable a user to provide multiple types of input to communicate with the computing device 400. The communications interface 440 can generally govern and manage the user input and system output. There is no restriction on operating on any particular hardware arrangement and therefore the basic features here may easily be substituted for improved hardware or firmware arrangements as they are developed.

Storage device 430 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 425, read only memory (ROM) 420, and hybrids thereof

The storage device 430 can include software modules 432, 434, 436 for controlling the processor 410. Other hardware or software modules are contemplated. The storage device 430 can be connected to the system bus 405. In one aspect, a hardware module that performs a particular function can include the software component stored in a computer-readable medium in connection with the necessary hardware components, such as the processor 410, bus 405, display 435, and so forth, to carry out the function.

FIG. 4B illustrates a computer system 450 having a chipset architecture that can be used in executing the described method and generating and displaying a graphical user interface (GUI). Computer system 450 is an example of computer hardware, software, and firmware that can be used to implement the disclosed technology. System 450 can include a processor 455, representative of any number of physically and/or logically distinct resources capable of executing software, firmware, and hardware configured to perform identified computations. Processor 455 can communicate with a chipset 460 that can control input to and output from processor 455. In this example, chipset 460 outputs information to output 465, such as a display, and can read and write information to storage device 470, which can include magnetic media, and solid state media, for example. Chipset 460 can also read data from and write data to RAM 475. A bridge 480 for interfacing with a variety of user interface components 485 can be provided for interfacing with chipset 460. Such user interface components 485 can include a keyboard, a microphone, touch detection and processing circuitry, a pointing device, such as a mouse, and so on. In general, inputs to system 450 can come from any of a variety of sources, machine generated and/or human generated.

Chipset 460 can also interface with one or more communication interfaces 490 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 455 analyzing data stored in storage 470 or 475. Further, the machine can receive inputs from a user via user interface components 485 and execute appropriate functions, such as browsing functions by interpreting these inputs using processor 455.

It can be appreciated that exemplary systems 400 and 450 can have more than one processor 410 or be part of a group or cluster of computing devices networked together to provide greater processing capability.

As one of ordinary skill in the art will readily recognize, the examples and technologies provided above are simply for clarity and explanation purposes, and can include many additional concepts and variations.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

What is claimed is:

1. A system, comprising:
at least one processor;
a network interface; and
memory including instructions that, when executed by the at least one processor, cause the system to:
define, using a first application programming interface (API), a logical resource variant of a logical service resource;
register, using the first API, the logical resource variant at a defining entity;
send, using the first API, software components for the logical resource variant to a Infrastructure as a Service (IaaS) system to associate the software components with the logical resource variant;
receive a call, from a second API, to enable create, read, update and delete (CRUD) operations for the logical resource variant;
assign an instantiating entity for the logical resource variant of the logical service resource; and
request the assigned instantiating entity to instantiate and configure the logical resource variant of the logical service resource at a hosting device.

2. The system of claim 1, wherein the logical service resource comprises an infrastructure cloud service, the infrastructure cloud service comprising one of a virtual router, virtual firewall, or a virtual private network.

3. The system of claim 2, wherein the logical resource variant comprises a name or metadata describing a variation of the logical service resource.

4. The system of claim 3, wherein the logical resource variant further includes information for a respective software configuration of the logical service resource, the software configuration associated with the software components of the logical resource variant.

5. The system of claim 1, wherein the software components comprise one or more drivers that provide functionality for the logical resource variant of the logical service resource.

6. The system of claim 5, wherein the one or more drivers comprise updated drivers that provide new or updated functionality for the logical resource variant.

7. The system of claim 1, wherein the defining entity comprises a service plugin, executing on the IaaS system, corresponding to the logical service resource, the second API comprises a representational state transfer (REST) API and the first API comprises an extended API of the REST API.

8. The system of claim 1, wherein the instructions further cause the at least one processor to:
send the software components and the logical resource variant to at least one instantiating entity.

9. The system of claim 8, wherein the software components and the logical resource variant are sent as part of a notification to the at least one instantiating entity.

10. The system of claim 8, wherein the at least one instantiating entity comprises a configuration system running separately from the IaaS system.

11. A computer-implemented method, comprising:
receiving, at an instantiating entity, a request from a defining entity for instantiating and configuring a logical service resource, the request including a logical resource variant and information regarding which hosting device should host the logical service resource;
searching a data structure to find a logical resource variant associated with a software component to use to instantiate the logical service resource; and
using the software component to instantiate and configure the logical service resource in a hosting device, the hosting device located separately from the instantiating entity.

12. The computer-implemented method of claim 11, further comprising:
responsive to the software component not being found in the data structure, sending a request to a defining entity to request and fetch a new software component for the logical resource variant.

13. The computer-implemented method of claim 12, further comprising:
storing the logical resource variant and the new software component in a data structure.

14. The computer-implemented method of claim 13, further comprising:
using the new software component to instantiate and configure the logical service resource in a hosting device.

15. A non-transitory computer-readable medium including instructions stored therein that, when executed by at least one computing device, cause the at least one computing device to:
define, using a first application programming interface (API), a logical resource variant of a logical service resource;
register, using the first API, the logical resource variant at a defining entity;
send, using the first API, software components for the logical resource variant to a Infrastructure as a Service (IaaS) system to associate the software components with the logical resource variant;
receive a call, from a second API, to enable create, read, update and delete (CRUD) operations for the logical resource variant;
assign an instantiating entity for the logical resource variant of the logical service resource; and
request the assigned instantiating entity to instantiate and configure the logical resource variant of the logical service resource at a hosting device.

16. The non-transitory computer-readable medium of claim 15, wherein the logical service resource comprises a infrastructure cloud service, the infrastructure cloud service comprising one of a virtual router, virtual firewall, or a virtual private network.

17. The non-transitory computer-readable medium of claim 15, wherein the logical resource variant comprises a name or metadata describing a variation of the logical service resource.

18. The non-transitory computer-readable medium of claim 15, wherein the logical resource variant further includes information for a respective software configuration of the logical service resource, the software configuration associated with the software components of the logical resource variant.

19. The non-transitory computer-readable medium of claim 15, wherein the software components comprises one or more drivers that provide functionality for the logical resource variant of the logical service resource.

20. The non-transitory computer-readable medium of claim 15, wherein the one or more drivers comprise updated drivers that provide new or updated functionality for the logical resource variant.
